(19) United States
(12) Patent Application Publication
(10) Pub. No.: US 2008/0200320 A1
(43) Pub. Date: Aug. 21, 2008

(54) PAPER CONVERTING ROLL WITH AN ELASTOMERIC ROLL COVER

(76) Inventors: Tyler Andrew Buckner, Mason, OH (US); Arnaldo Vazquez Santiago, Clarks Summit, PA (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 12/019,655

(22) Filed: Jan. 25, 2008

Related U.S. Application Data
(60) Provisional application No. 60/901,487, filed on Feb. 15, 2007.

(51) Int. Cl. D21G 1/02; F16C 13/00

(52) U.S. Cl. 492/48; 492/53

(57) ABSTRACT

A converting roll for processing web materials is disclosed. The converting roll has a core with a radius ranging from about 1 inch (2.54 cm) to about 12 inches (30.48 cm) and an outer surface. The converting roll also has an elastomeric roll cover disposed about the outer surface of the core. The elastomeric roll cover has a hardness ranging from about 80 P&J to about 140 P&J and a thickness ranging from about 0.25 inches (6.35 mm) to about 1.25 inches (31.75 mm).

### CROSS REFERENCE TO RELATED APPLICATIONS

This application claims the benefit of U.S. Provisional Application No. 60/901,487 filed Feb. 15, 2007.

### FIELD OF THE INVENTION

The present invention is directed to the field of paper converting. More particularly, the present invention is directed toward processing rolls having an elastomeric coating disposed thereon.

### BACKGROUND OF THE INVENTION

Web-based products, including paper products such as paper towels, bathroom tissues, facial tissues, paper napkins, and the like are widely used by consumers on a daily basis for a variety of household needs. These paper products may be embossed to increase the bulk, absorbency, softness, and aesthetic appeal of the final product.

Web substrates, such as paper webs that are used to make such web-based paper products, can be embossed. The embossing of web substrates can provide improvements to the resulting web substrate, such as increased bulk, improved water holding capacity, improved aesthetics, as well as assist in holding superposed plies of a web-based product together. Both single ply and multiple ply (or multi-ply) web substrates can be embossed. Multi-ply paper webs are web substrates that include at least two plies superimposed in face-to-face relationship to form a layered structure.

During a typical embossing process, a web substrate (or web) is fed through a nip formed between juxtaposed (generally axially) rolls or cylinders. Embossing protrusions on one, or both, of the rolls can compress and/or deform the web. If a typical multi-ply product is being formed, two or more plies are fed through the nip and regions of each ply are brought into a contacting relationship with the opposing ply. The embossed regions of the plies may produce an aesthetic pattern and provide a means for joining and maintaining the plies in face-to-face contacting relationship.

Embossing can be performed by one of several processes: knob-to-rubber impression, knob-to-knob embossing, or nested embossing. Knob-to-rubber (also referred to as rubber-to-steel) embossing typically comprises two rolls—a hard embossing roll having emboss protrusions, or emboss knobs, disposed in a desired pattern thereon, and a back-side soft impression roll. As the paper web is passed through the nip formed between the rolls, the emboss knobs impress the web against and into the back-side soft impression roll to deform the overall structure, and resulting appearance, of the web.

The soft impression roll used in such an embossing process can be constructed using a solid core covered by a rubber or rubberized roll cover formed from an elastomer. Exemplary elastomers may include natural rubber or synthetic elastomers such as neoprene, styrene-butadiene (SBR), nitrile, or chlorosulfonated polyethylene. Because elastomers are typically versatile materials, elastomeric covers can be used in a variety of papermaking applications. For example, rubber covers may be used in smoothing press rolls employed in the press section of a papermaking machine, in the dryer section of a papermaking machine in size press rolls, in breaker stack press rolls (in which non-uniformities in a web substrate are flattened or removed), or in a paper converting process (such as embossing).

It can be desirable for elastomeric covers employed in papermaking machines to meet certain minimum strength, elastic modulus, temperature and liquid resistance to survive the papermaking environment. Elastomeric covers used for the purposes listed above must often have different properties (such as hardness or modulus) depending on the specific purpose that it is being used for. Within each use, such as paper converting, there may be a myriad of parameters that may be used depending on the specific goal that is desired to be achieved.

The present invention improves upon the depth, crispness, and clarity of an embossment over the rubber-to-steel embossing of the prior art. Some prior art approaches attempt to achieve deep, crisp, and clear embossments involve increasing the softness and/or thickness of the elastomeric roll cover on the converting roll because it is thought that a soft, thick, and easily deformable elastomeric roll cover will allow steel emboss protrusions to ‘mold’ into the elastomeric roll and deliver a desirable product. However, this turns out not to be the case. Accordingly, the present invention takes an alternative route and, rather than using a soft and thick rubber roll cover, uses a harder, thinner elastomeric roll cover. Without being limited by theory, it is thought that by increasing hardness and decreasing thickness of the elastomeric roll cover, an increase in the nip width between the rubber roll and the emboss roll will result. Consequently, an increased pressure between the converting roll and the emboss roll results that can provide deep, crisp, and clear embossments that are significantly improved over the prior art.

### SUMMARY OF THE INVENTION

One embodiment of the present invention provides a converting roll comprising a core and an elastomeric roll cover. The core has a radius ranging from about 1 inch (2.54 cm) to about 12 inches (30.48 cm) and an outer surface. The elastomeric roll cover has a hardness ranging from about 80 P&J to about 140 P&J and a thickness ranging from about 0.25 inches (6.35 mm) to about 1.25 inches (31.75 mm). The elastomeric roll cover is disposed about the outer surface of said core.

Another embodiment of the present invention provides a converting roll having a core, a base layer disposed about an outer surface of the core, and an elastomeric roll cover disposed about an outer surface of said base layer. The core has a radius ranging from about 1 inch (2.54 cm) to about 12 inches (30.48 cm). The base layer has a hardness ranging from about 0.5 P&J to about 3.0 P&J and a base layer radius ranging from about 4 inches (10.16 cm) to about 12 inches (30.48 cm). The elastomeric roll cover has a hardness ranging from about 80 P&J to about 140 P&J and a thickness ranging from about 0.25 inches (6.35 mm) to about 1.75 inches (44.5 mm).

Yet another embodiment of the present invention provides a converting roll having a core, a base layer disposed about a surface of the core, and an elastomeric roll cover disposed about a surface of the base layer. The core has a radius ranging from about 5 inches (12.7 cm) to about 10 inches (25.4 cm). The base layer has a hardness ranging from about 1.0 P&J to about 2.0 P&J and a base layer radius ranging from about 5 inches (12.7 cm) to about 11 inches (27.94 cm). The elastomeric roll cover has a hardness ranging from about 95 P&J (±5 P&J) to about 115 P&J (±5 P&J) and a thickness ranging from about 0.75 inches (1.91 cm) to about 1.25 inches (31.75 cm).

### BRIEF DESCRIPTION OF THE DRAWINGS

FIG. 1A is a plan view of an embodiment of a converting roll according to the present invention;

FIG. 1B is a plan view of an embodiment of a base layer containing converting roll according to the present invention;

FIG. 2A is a cross sectional view of a portion of the converting roll shown in FIG. 1A taken along the line 2A-2A;

FIG. 2B is a cross sectional view of a portion of the converting roll shown in FIG. 1B taken along the line 2B-2B;

FIG. 3 is a cross-sectional view of an embodiment of an apparatus that can be used to perform embossing; and,

FIG. 4 is an elevational view of an emboss protrusion.

### DETAILED DESCRIPTION OF THE INVENTION

### Definitions

“Paper product,” as used herein refers to any formed, fibrous structure products, traditionally, but not necessarily, comprising cellulose fibers. In one embodiment, the paper products of the present invention include tissue-towel and/or paper products.

“Tissue and/or towel paper product” refers to creped and/or uncreped products comprising paper tissue or paper towel technology in general, including, but not limited to, conventional felt-pressed or conventional wet-pressed tissue paper, pattern densified tissue paper, starch substrates, and high bulk, uncompacted tissue paper. Exemplary, but non-limiting examples of tissue-towel paper products include paper toweling, facial tissue, bath tissue, table napkins, and the like.

“Ply” or “Plies,” as used herein, means an individual fibrous structure or sheet of fibrous structure, optionally to be disposed in a substantially contiguous, face-to-face relationship with other plies, forming a multi-ply fibrous structure. It is also contemplated that a single fibrous structure can effectively form two “plies” or multiple “plies”, for example, by being folded on itself. In one embodiment, the ply has an end use as a tissue and/or towel paper product. A ply may comprise one or more wet-laid layers, air-laid layers, and/or combinations thereof. If more than one layer is used, it is not necessary for each layer to be made from the same fibrous structure. Further, the layers may or may not be homogenous within a layer. The actual makeup of a tissue paper ply is generally determined by the desired benefits of the final tissue-towel paper product, as would be known to one of skill in the art. The fibrous structure may comprise one or more plies of non-woven materials in addition to the wet-laid and/or air-laid plies.

“Paper web,” as used herein, means an arrangement of fibers produced in any papermaking machine known in the art to create a ply of paper. “Fiber” means an elongate particulate having an apparent length greatly exceeding its apparent width. More specifically, and as used herein, fiber refers to such fibers suitable for a papermaking process.

“Basis Weight,” as used herein, is the weight per unit area of a sample reported in lbs/3000 ft² or g/m².

“Machine Direction” or “MD,” as used herein, means the direction parallel to the flow of the fibrous structure through the papermaking machine and/or product manufacturing equipment.

“Cross Machine Direction” or “CD,” as used herein, means the direction perpendicular to the machine direction in the same plane of the fibrous structure and/or fibrous structure product comprising the fibrous structure.

“Embossing,” as used herein, refers to the process of deflecting a relatively small portion of a cellulosic fibrous structure normal to its plane and impacting the projected portion of the fibrous structure against another surface to permanently disrupt the fiber to fiber bonds.

“Converting roll,” as used herein is a roll that may be used in the paper embossing process for accepting the protrusions from a male embossing roll. In some embodiments, the converting roll comprises an elastomeric roll cover and a core. In other embodiments, the converting roll comprises an elastomeric roll cover, base layer, and core.

“Roll cover,” as used herein, refers to a cover that can be disposed upon, and releasably attached to, the external surface of a converting, steel or other metal or solid core roll. The roll cover can be made of any material known in the art.

“Rubber roll cover” also known to those in the art as an “elastomeric roll cover,” as used herein, refers to a roll cover that is constructed from rubber or an elastomer.

“Hardness,” as used herein, refers to the stiffness of a material as characterized by the difference in penetration depth of the material using a ball of a specified dimension under two conditions of contact. First, using a small initial force and second, using a much larger final force. The differential penetration is taken at a specified time and converted to a hardness scale value. Hardness, as described herein is described in units of Pusey & Jones (P&J). The hardness may be measured by the American Society for Testing and Materials (ASTM) standard #D531-00 (2005).

### Paper Web

Rubber-to-steel embossing is equally applicable to all types of consumer paper products such as paper towels, toilet tissue, facial tissue, napkins, and the like. Further, rubber-to-steel embossing may be used on paper webs formed from a variety of paper making fibers such as natural fibers, synthetic fibers, as well as any other suitable fibers, starches, and combinations thereof. Paper making fibers useful in the present invention include cellulosic fibers commonly known as wood pulp fibers. Applicable wood pulps include chemical pulps, such as Kraft, sulfite and sulfate pulps; mechanical pulps including groundwood, thermomechanical pulp; chemithermomechanical pulp; chemically modified pulps, and the like. Chemical pulps, however, may be preferred in tissue towel embodiments since they are known to those of skill in the art to impart a superior tactical sense of softness to tissue sheets made therefrom. Pulps derived from deciduous trees (hardwood) and/or coniferous trees (softwood) can be utilized herein. Such hardwood and softwood fibers can be blended or deposited in layers to provide a stratified web. Exemplary layering embodiments and processes of layering are disclosed in U.S. Pat. Nos. 3,994,771 and 4,300,981. Additionally, fibers derived from non-wood pulp such as cotton linters, bagesse, and the like, can be used. Additionally, fibers derived from recycled paper, which may contain any or all of the pulp categories listed above, as well as other non-fibrous materials such as fillers and adhesives used to manufacture the original paper product may be used in the present web. In addition, fibers and/or filaments made from polymers, specifically hydroxyl polymers, may be used in the present invention. Non-limiting examples of suitable hydroxyl polymers include polyvinyl alcohol, starch, starch derivatives, chitosan, chitosan derivatives, cellulose derivatives, gums, arabinans, galactans, and combinations thereof. Additionally, other synthetic fibers such as rayon, lyocel, polyester, polyethylene, and polypropylene fibers can be used within the scope of the present invention. Further, such fibers may be latex bonded. Other materials are also intended to be within the scope of the present invention as long as they do not interfere or counter act any advantage presented by the instant invention.

Synthetic fibers useful herein include any material, such as, but not limited to, those selected from the group consisting of polyesters, polypropylenes, polyethylenes, polyethers, polyamides, polyhydroxyalkanoates, polysaccharides, and combinations thereof. The synthetic fiber may comprise a polymer. The polymer may be any material, such as, but not limited to, those materials selected from the group consisting of polyesters, polyamides, polyhydroxyalkanoates, polysaccharides and combinations thereof. More specifically, the material of the polymer segment may be selected from the group consisting of poly(ethylene terephthalate), poly(butylene terephthalate), poly(1,4-cyclohexylenedimethylene terephthalate), isophthalic acid copolymers (e.g., terephthalate cyclohexylene-dimethylene isophthalate copolymer), ethylene glycol copolymers (e.g., ethylene terephthalate cyclohexylene-dimethylene copolymer), polycaprolactone, poly(hydroxyl ether ester), poly(hydroxyl ether amide), polyesteramide, poly(lactic acid), polyhydroxybutyrate, and combinations thereof.

Further, the synthetic fibers can be a single component (i.e., single synthetic material or mixture makes up entire fiber), bi-component (i.e., the fiber is divided into regions, the regions including two or more different synthetic materials or mixtures thereof and may include co-extruded fibers) and combinations thereof. It is also possible to use bicomponent fibers, or simply bicomponent or sheath polymers. Non-limiting examples suitable bicomponent fibers are fibers made of copolymers of polyester (polyethylene terephthalate)/polyester (polyethylene terephthalate) (otherwise known as “CoPET/PET” fibers), which are commercially available from Fiber Innovation Technology, Inc., Johnson City, Tenn. These bi-component fibers can be used as a component fiber of the structure, and/or they may be present to act as a binder for the other fibers present. Any or all of the synthetic fibers may be treated before, during, or after the process of the present invention to change any desired properties of the fibers. For example, in certain embodiments, it may be desirable to treat the synthetic fibers before or during the papemmaking process to make them more hydrophilic, more wettable, etc.

The fibrous structure may comprise a tissue-towel paper product known in the industry. Exemplary, but non-limiting, embodiments of these substrates may be made according U.S. Pat. Nos. 4,191,609; 4,300,981; 4,514,345; 4,528,239; 4,529,480; 4,637,859; 5,245,025; 5,275,700; 5,328,565; 5,334,289; 5,364,504; 5,527,428; 5,556,509; 5,628,876; 5,629,052; 5,637,194; 5,411,636; EP 677612; and U.S. Patent Application 2004/0192136A1.

The fibrous structure substrates may be manufactured via a wet-laid making process where the resulting web may be comprised of fibrous structure selected from the group consisting of: through-air-dried fibrous structure plies, differential density fibrous structure plies, wet laid fibrous structure plies, air laid fibrous structure plies, conventional fibrous structure plies, and combinations thereof.

Optionally, the fibrous structure substrate may be foreshortened by creping or by wet microcontraction. Creping and/or wet microcontraction are disclosed in U.S. Pat. Nos. 6,048,938; 5,942,085; 5,865,950; 4,440,597; 4,191,756; and 6,187,138.

The substrate which comprises the fibrous structure of the present invention may be cellulosic, non-cellulosic, or a combination of both. The substrate may be conventionally dried using one or more press felts or through-air dried. If the substrate which comprises the paper according to the present invention is conventionally dried, it may be conventionally dried using a felt which applies a pattern to the paper as taught by commonly assigned U.S. Pat. No. 5,556,509 and PCT Application WO 96/00812. The substrate which comprises the paper according to the present invention may also be through air dried. A suitable through air dried substrate may be made according to commonly assigned U.S. Pat. No. 4,191,609.

In one embodiment, the substrate which comprises the paper according to the present invention is through air dried on a belt having a patterned framework. The belt according to the present invention may be made according to any of commonly assigned U.S. Pat. Nos. 4,637,859; 4,514,345; 5,328,565; and 5,334,289.

### Converting Roll

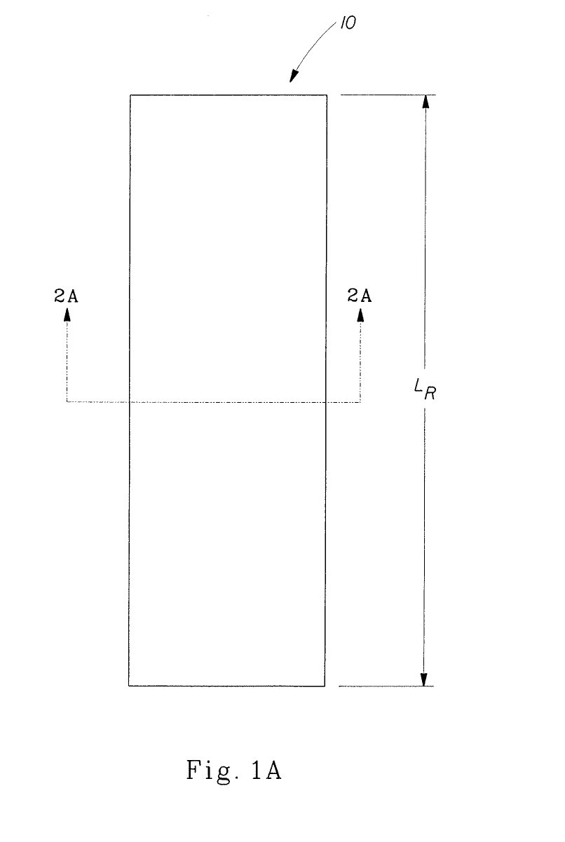

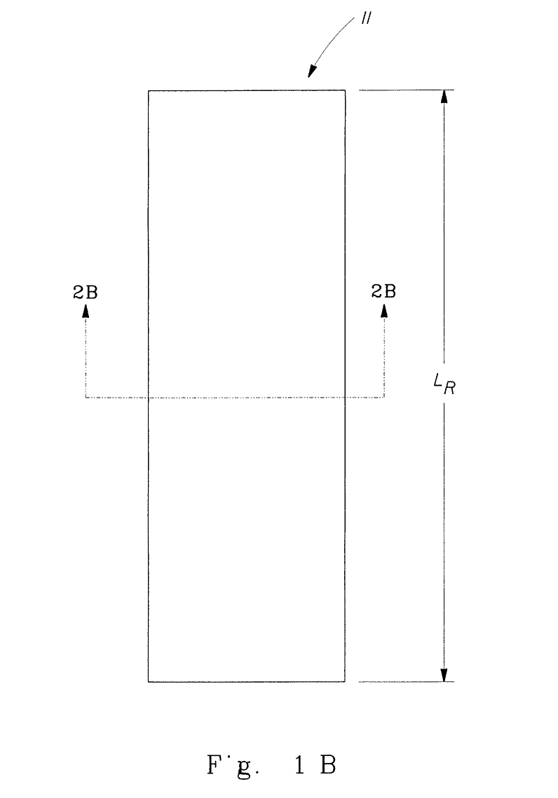

FIG. 1A shows an exemplary embodiment of a converting roll 10 of the present invention. In a preferred, but non-limiting, embodiment the converting roll 10 is from about 90 inches (2.29 m) to about 120 inches (3.05 m) in length, L_{R}. In another embodiment L_{R} is from about 100 inches (2.54 m) to about 110 inches (2.79 m) in length. In another embodiment, L_{R} is 105 inches (2.67 m) in length.

FIG. 1B shows an embodiment of a converting roll with a base layer 11 of the present invention. In one embodiment the converting roll with a base layer 11 is from about 90 inches (2.29 m) to about 120 inches (3.05 m) in length, L_{R}. In another embodiment L_{R} is from about 100 inches (2.54 m) to about 110 inches (2.79 m) in length. In another embodiment, L_{R} is about 105 inches (2.67 m) in length.

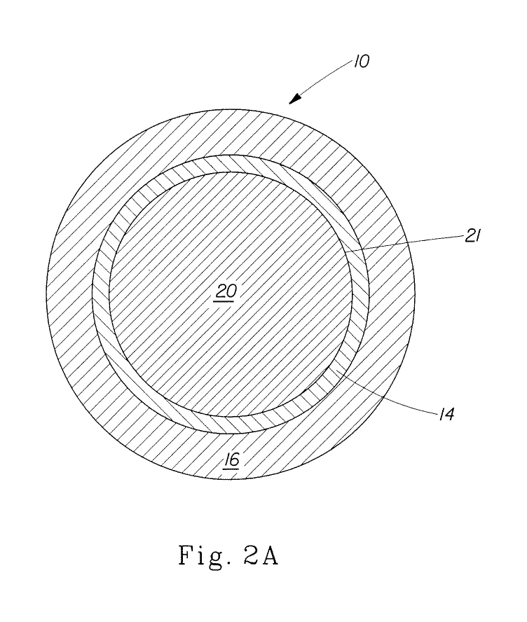

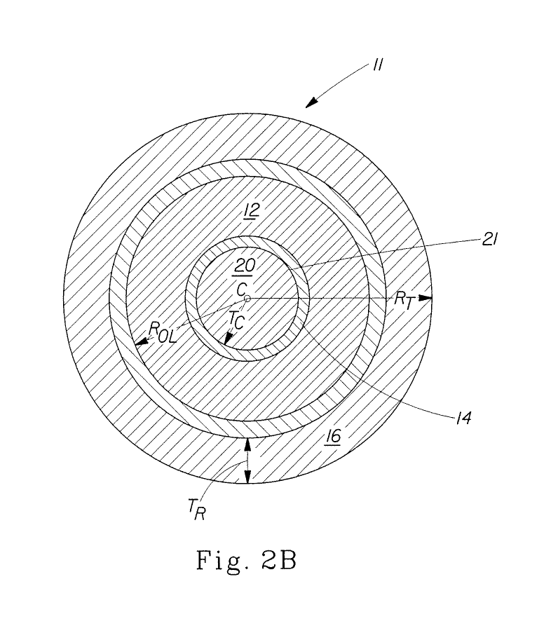

FIG. 2A is a cross-sectional view of an exemplary embodiment of a converting roll 10 of FIG. 1A taken along the line 2A-2A. The converting roll 10 preferably comprises a core 20 and an elastomeric roll cover 16. Elastomeric roll cover 16 is preferably disposed about the core 20 and attached thereto by a first adhesive layer 14 disposed between the core 20 and the elastomeric roll cover 16. The first adhesive layer 14 attaches the elastomeric roll cover 16 to the outer surface 21 of the core 20.

In one exemplary embodiment, the core 20 can be a substantially cylindrical structure typically formed of steel or other metal. In certain embodiments, the core 20 is from about 10 inches (25.4 cm) to about 22 inches (55.9 cm) in diameter. In another embodiment, the core is from about 12 inches (30.5 cm) to about 20 inches (50.8 cm) in diameter. In one embodiment, the core is about 19.6 inches (49.8 cm) in diameter. In another embodiment, the core is about 12.5 inches (31.8 cm) in diameter. In certain embodiments the core 20 can be hollow and in certain other embodiments the core 20 can be solid.

FIG. 2B is a cross-sectional view of an exemplary embodiment of the base layer containing converting roll 11 of FIG. 1B taken along the line 2B-2B. In this embodiment, a base layer 12 is disposed about the outer surface 21 of the core 20. An elastomeric roll cover 16 is preferably disposed about the outer surface 13 of the base layer 12. In some embodiments, a second adhesive layer 18 can be disposed between the base layer 12 and the elastomeric roll cover 16. Additionally, a first adhesive layer 14 is disposed between the base layer 12 and core 20.

In certain embodiments, the outer surface 13 of the base layer 12 and/or the inner surface of the elastomeric roll cover 16 and/or outer surface 21 of the core 20 may be treated by blasting, sanding, sandblasting, chemically treated, or the like to prepare the respective surface for application of a bonding agent.

In the embodiment shown in FIG. 2A, the first adhesive layer 14 comprises an adhesive (typically a solvent-based or water-based adhesive) that attaches the surface 21 of core 20 to the elastomeric roll cover 16. In this embodiment, the first adhesive layer 14 creates a bond between the surface 21 of core 20 and the elastomeric roll cover 16 having a tensile bond strength of from about 1200 psi (8.27 MPa) to about 5000 psi (34.5 MPa).

In the embodiment shown in FIG. 2B, the first adhesive layer 14 provides a bond between the surface 21 of core 20 and the base layer 12 having a tensile bond strength of from about 1200 psi (8.27 MPa) to about 5000 psi (34.5 MPa). In this embodiment, the second adhesive layer 18 can provide a bond between the surface 13 of base layer 12 and the elastomeric roll cover 16 of from about 1200 psi (8.27 MPa) to about 5000 psi (34.5 MPa). One of skill in the art will appreciate that the adhesive comprising the first adhesive layer 14 may be selected such that the first adhesive layer 14 is compatible with the materials comprising either the surface 21 of core 20, the base layer 12, and/or the elastomeric roll cover 16. Specifically, the first adhesive layer 14 and second adhesive layer 18 should be selected to provide a strong bond between the selected components without causing any reactions, etching, or other unwanted effects. In a preferred embodiment, the first adhesive layer 14 or second adhesive layer 18 may contain one or more additives such as a curing agent. The first adhesive layer 14 or second adhesive layer may be applied to the surface 21 of core 20 or the surface 13 of base layer 12 in any manner known to be suitable to those skilled in the art for applying adhesives to a surface. Non-limiting examples of methods for applying such an adhesive layer include: spraying, brushing, immersion, scraping, and the like. Without wishing to be limited by theory, if a solvent-based adhesive is used for the first adhesive layer 14, it may be desirable to allow the solvent to evaporate before the elastomeric roll cover 16 is disposed upon an adhesive layer. This can result in the overall reduction in the formation of bubbles between either the surface of the base layer 12 or core 20 and the elastomeric roll cover 16 during the curing process.

Alternatively, a converting roll 10 comprising an elastomeric roll cover 16 disposed about a core 20 or a base layer containing converting roll 11 comprising an elastomeric roll cover 16 disposed about a base layer 12 and a core 20 may be purchased from a vendor such as Xerium Technologies, Inc/Stowe Woodward (Youngsville, N.C.), Valley Roller Company, Inc. (Appleton, Wis.), American Roller Co. (Union Grove, Wis.).

The converting roll 10 or base layer containing converting roll 11 may have a total radius, RT, measured from the center point C of the converting roll 10 or base layer containing converting roll 11 to the outer surface of the elastomeric roll cover 16 of from about 4 inches (10.2 cm) to about 14 inches (35.6 cm). In another embodiment, RT is from about 5 inches (12.7 cm) to about 12 inches (30.5 cm). In a preferred embodiment, RT is about 6.5 inches (16.5 cm). In another embodiment, RT is about 11 inches (27.5 cm).

### Converting Roll in an Embossing Arrangement

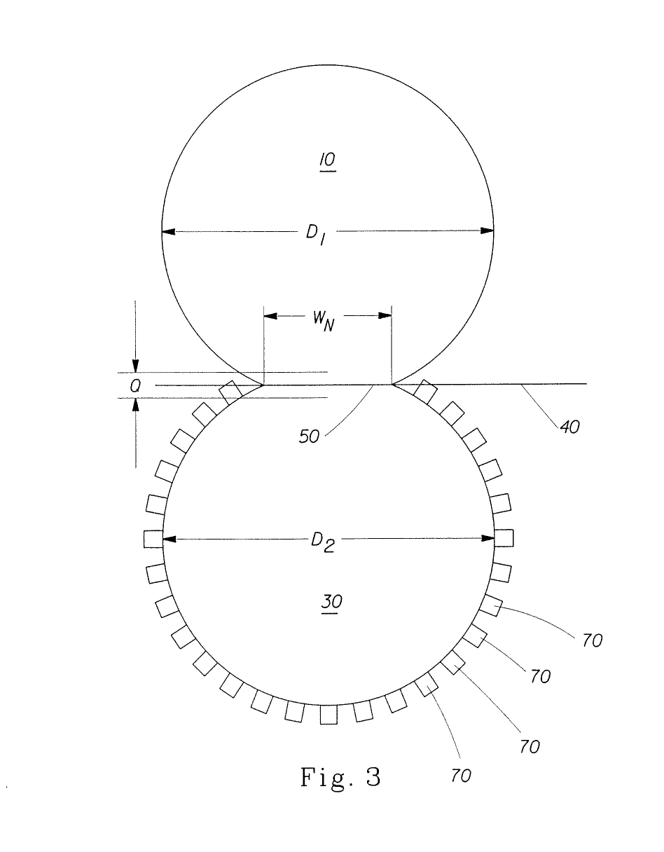

FIG. 3 shows one embodiment of an exemplary embossing configuration 200. It should be understood that in any apparatus comprising elements of the present invention a converting roll 10 may be used interchangeably with a converting roll having a base layer 11.

In one preferred embodiment, the longitudinal axis of converting roll 10 is preferably aligned parallel to the longitudinal axis of emboss roll 30. A paper web 40 is then passed through the nip 50 formed between the converting roll 10 and the emboss roll 30. Emboss roll 30 can be provided with a plurality of embossing knobs that effectively impress the paper web 40 into the elastomeric roll cover 16 disposed upon converting roll 10 at the nip 50 to deform the structure of the paper web 40. The nip 50 width, W_{N}, is the width of the nip 50. In a preferred embodiment, the converting roll 10 and emboss roll 30 are disposed so that a compressive force exists therebetween. In this manner, the compressive force due to the pressures produced between converting roll 10 and emboss roll 30 can be applied to the paper web 40 disposed therebetween. In one embodiment, the nip width, W_{N}, of the present invention is from about 1 inch (2.54 cm) to about 2.5 inches (6.35 cm). In one embodiment, the pressure at the nip 50 of the present invention is from about 55 psi (37.9 MPa) to about 440 psi (303 MPa). It was found that the relationship between calendar nip with (W_{N}), the nip 50 load, converting roll 10 and emboss roll 30 dimensions, and the physical properties of elastomeric roll cover 16 follows the relationship:

$${W}_{N} = [ \frac{5.8 \times {10}^{- 6} {LTD}_{1} {D}_{2} {P}^{1.35}}{{D}_{1} + {D}_{2}} ] 0.81 {( {D}_{1} )}^{- 0.232}$$

where:

W_{N} is the nip 50 width in inches;

L is the nip 50 load in pounds per linear inch (PLI);

T is the thickness of the elastomeric roll cover 16 in inches;

D₁ is the converting roll 10 diameter in inches;

D₂ is the embossing roll 30 diameter in inches; and,

P is the hardness of the elastomeric roll cover 16 in units of P&J.

### Embossing Roll

An emboss roll 30 that may be used in the present invention may comprise one or more protrusions 70. Without desiring to be limited by theory, the force applied to the paper web 40, as well as the distribution of the resulting pressure on the surface of the paper web 40, is directly affected by the shape of the surface of a protrusion 70 contacting the paper web 40 as well as the overall surface area of a protrusion 70 contacting the paper web 40.

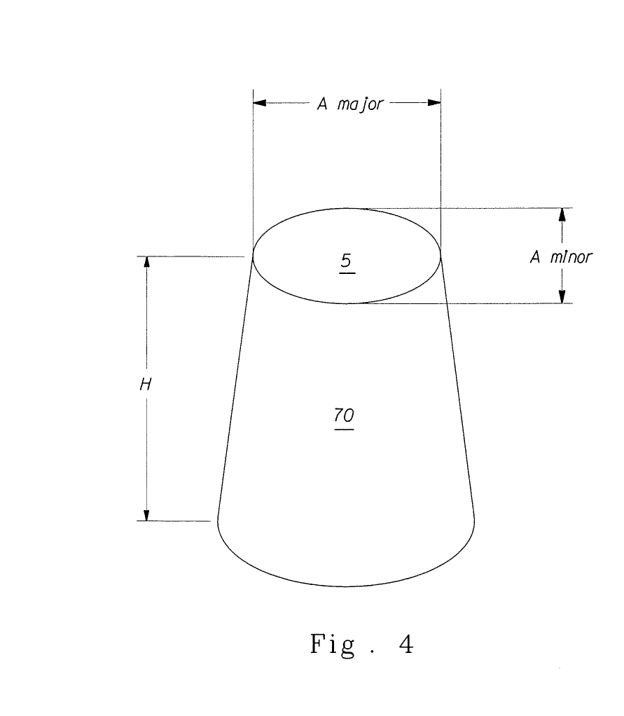

FIG. 4 shows an exemplary protrusion 70 suitable for use with emboss rolls 30 in the present invention. The shape of the contacting surface, S, of the protrusion 70 that contacts paper web 40 may be selected from any shape. In a preferred embodiment, the contacting surface, S, of the protrusion 70 is oval (i.e., oblong in shape). In such an embodiment, it is preferred that protrusion 70 have a minor axis, Aₘᵢₙₒᵣ, having dimensions from about 0.04 inches (1.01 mm) to about 0.1 inches (2.5 mm) in length. In another embodiment, the minor axis, Aₘᵢₙₒᵣ, of the protrusion 70 surface is about 0.066 inches (1.68 mm) long. Preferably, the surface of protrusion 70 has a major axis, Aₘₐⱼₒᵣ, ranging from about 0.09 inches (2.29 mm) to about 0.16 inches (4.06 mm). In another embodiment, the major axis, Aₘₐⱼₒᵣ, of the protrusion 70 surface is from about 0.11 inches (2.79 mm) to about 0.14 inches (3.56 mm) in length. In another embodiment, the major axis, Aₘₐⱼₒᵣ, of the protrusion 70 surface is about 0.132 inches (3.35 mm) in length. In one embodiment, the height, H, of protrusion 70 is from about 0.05 inches (1.27 mm) to about 0.1 inch (2.54 mm). In another embodiment, the height, H, of protrusion 70 is about 0.075 inches (1.91 mm).

### Elastomeric Roll Cover

In one embodiment of the present invention, the design is optimized such the relationship between the thickness and the hardness of the elastomeric roll cover 16 provides deep, crisp, and clear embossments. Without being limited by theory, it is thought that to provide effective pressure at the nip 50, the elastomeric roll cover 16 is preferably hard and thin rather than soft and thick. In one embodiment, the hardness of the elastomeric roll cover is from about 80 P&J (±5 P&J) to about 140 P&J (±5 P&J). In another embodiment, the hardness is from about 90 P&J (±5 P&J) to about 130 P&J (+5 P&J). In another embodiment, the hardness is from about 95 P&J (±5 P&J) to about 115 P&J (±5 P&J). In one embodiment, the elastomeric roll cover 16 has a thickness, TR, ranging from about 0.25 inches (6.35 mm) to about 1.75 inches (44.45 mm). In another embodiment, the elastomeric roll cover 16 thickness, T_{R}, is from about 0.5 inches (12.7 mm) to about 1.5 inches (38.1 mm). In another embodiment, the elastomeric roll cover 16 thickness is from about 0.75 inches (19.05 mm) to about 1.25 inches (31.75 mm).

One of skill in the art may appreciate that it is possible to construct an elastomeric roll cover 16 using different materials depending on the intended function of the particular roll. Using an elastomeric roll cover 16 on the converting roll 10 can allow for quicker and less expensive reconditioning of the converting roll 10 than replacing the entire converting roll 10. When a roll cover is damaged or worn, it may be reground easily, or stripped from the converting roll 10 and replaced at lower cost than replacing the entire converting roll 10. By using different roll cover materials and formulations, the surface characteristics of the converting roll 10 can be optimized for the location in the machine in which the converting roll 10 is installed. Thus, desired and necessary hardness, abrasion and wear resistance, chemical resistance and other properties can be achieved. Both natural rubbers and synthetic elastomers have been used in paper converting roll covers. It also is known to use a plurality of different materials in layers between the roll shell and the top layer of the roll cover, as transition layers between the shell and the top layer, to promote roll cover life. Examples of roll covers are shown in U.S. Pat. Nos. 5,887,517; 6,173,496; 6,874,232; and 7,008,513. In addition, synthetic fiber or particle fillers have been used mixed with the elastomer to improve paper machine roll performance, and to increase roll cover life. Examples of such fiber or particle fillers are shown in U.S. Pat. No. 6,918,865.

Alternatively, a suitable elastomeric roll cover 16 may be purchased from a commercial vendor such as Xerium Technologies, Inc/Stowe Woodward (Youngsville, N.C.), Valley Roller Company, Inc. (Appleton, Wis.), American Roller Co. (Union Grove, Wis.).

### Converting Roll: Core

The core 20 may be constructed from any material known in the art. Nonlimiting examples of materials that may be used are described in U.S. Pat. Nos. 6,445,906; 4,178,664; 4,998,333; and 5,091,027. A suitable hard core 20 may also be readily available through a variety of vendors, such as Xerium Technologies, Inc/Stowe Woodward (Youngsville, N.C.), Valley Roller Company, Inc. (Appleton, Wis.), American Roller Co. (Union Grove, Wis.).

In one embodiment, the core 20 has a radius, R_{c}, of from about 1 inch (2.54 cm) to about 12 inches (30.48 cm). In another embodiment, the core has a radius of from about 2.5 inches (6.35 cm) to about 10 inches (25.4 cm). In another embodiment, the core has a radius of from about 5 inches (12.7 cm) to about 10 inches (25.4 cm). In another embodiment, the core has a radius of from about 6 inches (15.24 cm) to about 8 inches (20.32 cm).

### Converting Roll Base Layer

The base layer 12 of the present invention may be made from any material known in the art. A base layer may be obtained commercially from a variety of vendors, such as Xerium Technologies, Inc/Stowe Woodward (Youngsville, N.C.), Valley Roller Company, Inc. (Appleton, Wis.), American Roller Co. (Union Grove, Wis.).

In one embodiment, the base layer 12 radius, R_{BL}, which describes the distance from the center of the converting roll 10 to the outer surface of the base layer 12, ranges from about 4 inches (10.16 cm) to about 12 inches (30.48 cm). In another embodiment, the base layer 12 radius is from about 5 inches (12.7 cm) to about 11 inches (27.54 cm). In another embodiment, the base layer 12 radius is from about 6 inches (15.24 cm) to about 10 inches (25.4 cm).

Without being limited by theory, it is thought that to provide effective pressure at the nip 50, the base layer 12 must provide adequate support against the elastomeric roll cover 16. In one embodiment, the hardness of the base layer 12 is from about 0.5 P&J to about 3.0 P&J. In another embodiment, the hardness of the base layer 12 is from about 1 P&J to about 2 P&J.

### EXAMPLE

### Conventional Converting Roll

A paper web can comprise a plurality of plies where each ply is made of 55 percent northern softwood kraft, 30 percent Eucalyptus, and has a basis weight of approximately 13.5 pounds per 3000 square feet (21.97 gsm).

Only one ply is embossed in a rubber to steel embossing process. The emboss roll has emboss protrusions (embossment knobs) that are elliptically shaped having a major axis of 0.129 inches (3.28 mm), minor axis of 0.068 inches (1.73 mm), and height 0.070 inches (1.78 mm) (protrusion from the plane of the emboss roll). The conventional converting roll is constructed of a steel core about 110 inches (2.79 m) long with a radius of 6.0 inches (15.2 cm). An elastomeric rubber roll is disposed over the outer surface of the steel core. The elastomeric rubber roll is about 1.5 inches (3.81 cm) thick and has a hardness of about 100 P&J (±5 P&J).

The converting roll is aligned in an axially parallel configuration with the embossing roll. The paper web is passed through the nip, having a variable nip width of from about 1.5 inches (3.81 cm) to about 2.1 inches (15.33 cm) that forms between the rolls. The paper web is passed through the nip at a rate of about 1500 feet per minute (457 m/min).

The embossed paper web then has glue applied to the embossments that are formed on the surface of the paper web and is laminated. The embossments are then measured (as described in the “Embossment Structure Measurement Method” section below).

### Conventional Converting Roll

| PR nip | Emboss Depth |
|---|---|
| (inches) | (microns) |
| 2.10 | 569 |
| 2.10 | 570 |
| 1.80 | 444 |
| 1.50 | 362 |
| 1.50 | 384 |

### EXAMPLE

### Present Invention Converting Roll

Returning again to FIG. 3, an exemplary paper web made by an apparatus comprising the present invention may comprise two plies of cellulosic fibers. Each ply is preferably made of 55 percent northern softwood kraft, 30 percent Eucalyptus, and has a basis weight of approximately 13.5 pounds per 3000 square feet (21.97 gsm). Preferably, only one ply is embossed in a rubber to steel embossing process.

The emboss roll 30 has protrusions 70 (embossment knobs) that are elliptically shaped having a major axis of 0.129 inches (3.28 mm), minor axis of 0.068 inches (1.73 mm), and height 0.070 inches (1.78 mm) (from the plane of the surface of emboss roll 30). The converting roll 10 is constructed of a steel core about 110 inches (2.79 m) long with a radius of 6.25 inches (15.2 cm). An elastomeric roll cover 16 is disposed over the outer surface of the steel core 20. The elastomeric roll cover 16 is about 0.75 inches (1.91 mm) thick and has a hardness of about 105 P&J (±5 P&J).

Preferably, the converting roll 10 is aligned in an axially parallel configuration with the emboss roll 30. The paper web 40 is passed through the nip 50, having a variable nip 50 width of from about 1.5 inches (3.81 cm) to about 2.1 inches (5.33 cm) that forms between the respective emboss roll 30 and converting roll 10. The paper web 40 is passed through the nip at a rate of about 1500 feet per minute (457 m/min).

The embossed paper web 40 then preferably has glue applied to the embossments that are formed on the surface of the paper web 40 and is then subsequently laminated. The embossments are then measured (as described in the “Embossment Structure Measurement Method” section below).

### Present Invention Converting Roll

| PR nip | Emboss Depth |
|---|---|
| (inches) | (microns) |
| 2.10 | 679 |
| 2.10 | 688 |
| 1.80 | 629 |
| 1.50 | 499 |
| 1.50 | 501 |

### Embossment Structure Measurement Method

The geometric characteristics of the embossment structure of the present invention are measured using an Optical 3D Measuring System MikroCAD compact for paper measurement instrument (the “GFM MikroCAD optical profiler instrument”) and ODSCAD Version 4.14 software available from GFMesstechnik GmbH, Warthestraβe E21, D14513 Teltow, Berlin, Germany. The GFM MikroCAD optical profiler instrument includes a compact optical measuring sensor based on digital micro-mirror projection, consisting of the following components:
A) A DMD projector with 1024×768 direct digital controlled micro-mirrors.
B) CCD camera with high resolution (1280×1024 pixels).
C) Projection optics adapted to a measuring area of at least 160×120 mm.
D) Recording optics adapted to a measuring area of at least 160×120 mm;
E) Schott KL1500 LCD cold light source.
F) A table stand consisting of a motorized telescoping mounting pillar and a hard stone plate;
G) Measuring, control and evaluation computer.
H) Measuring, control and evaluation software ODSCAD 4.14.
I) Adjusting probes for lateral (XY) and vertical (Z) calibration.

The GFM MikroCAD optical profiler system measures the height of a sample using the digital micro-mirror pattern projection technique. The result of the analysis is a map of surface height (Z) versus XY displacement. The system should provide a field of view of 160×120 mm with an XY resolution of 21 μm. The height resolution is set to between 0.10 μm and 1.00 μm. The height range is 64,000 times the resolution. To measure a fibrous structure sample, the following steps are utilized:
1. Turn on the cold-light source. The settings on the cold-light source are set to provide a reading of at least 2,800 k on the display.
2. Turn on the computer, monitor, and printer, and open the software.
3. Verify calibration accuracy by following the manufacturer's instructions.
4. Select “Start Measurement” icon from the ODSCAD task bar and then click the “Live Image” button.
5. Obtain a fibrous structure sample that is larger than the equipment field of view and conditioned at a temperature of 73° F.±2° F. (about 23° C.±1° C.) and a relative humidity of 50%±2% for 2 hours. Place the sample under the projection head. Position the projection head to be normal to the sample surface.
6. Adjust the distance between the sample and the projection head for best focus in the following manner. Turn on the “Show Cross” button. A blue cross should appear on the screen. Click the “Pattern” button repeatedly to project one of the several focusing patterns to aid in achieving the best focus. Select a pattern with a cross hair such as the one with the square. Adjust the focus control until the cross hair is aligned with the blue “cross” on the screen.
7. Adjust image brightness by increasing or decreasing the intensity of the cold light source or by altering the camera gains setting on the screen. When the illumination is optimum, the red circle at the bottom of the screen labeled “I.O.” will turn green.
8. Select “Standard” measurement type.
9. Click on the “Measure” button. The sample should remain stationary during the data acquisition.
10. To move the data into the analysis portion of the software, click on the clipboard/man icon.
11. Click on the icon “Draw Cutting Lines.” On the captured image, “draw” a cutting line that extends from the center of a negative embossment through the centers of at least six negative embossments, ending on the center of a final negative embossment. Click on the icon “Show Sectional Line Diagram.” Move the cross-hairs to a representative low point on one of the left hand negative embossments and click the mouse. Then move the cross-hairs to a representative low point on one of the right hand negative embossments and click the mouse. Click on the “Align” button by marked point's icon. The Sectional Line Diagram is now adjusted to the zero reference line.
12. Measurement of Emboss Height, “a”. Using the Sectional Line Diagram described in step 11, click the mouse on a representative low point of a negative emboss, followed by clicking the mouse on a representative point on the nearby upper surface of the sample. Click the “Vertical” distance icon. Record the distance measurement. Repeat the previous steps until the depth of six negative embossments have been measured. Take the average of all recorded numbers and report in mm, or mm, as desired. This number is the embossment height.
13. Measurement of Emboss Area, A. Using the Sectional Line Diagram of step 11, select with the mouse two points on each wall of a negative embossment that represents 50% of the depth measured in step 12. Click the “horizontal distance” icon. The horizontal distance is the diameter of an equivalent circle. The area of that circle is calculated using the formula Area=2π(d/2)² and is recorded as the Equivalent Emboss Area. If the embossment shape is elliptical or irregular, more sectional lines are needed, cutting through the embossment from different directions, to calculate the equivalent area. Repeat these steps for the six negative embossments measured in step 12.

It is noted that terms like “specifically,” “preferably,” “typically”, “generally”, and “often” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention. It is also noted that terms like “substantially” and “about” are utilized herein to represent the inherent degree of uncertainty that may be attributed to any quantitative comparison, value, measurement, or other representation.

The dimensions and values disclosed herein are not to be understood as being strictly limited to the exact dimension or value recited. Instead, unless otherwise specified, each such dimension and/or value is intended to mean both the recited dimension and/or value and a functionally equivalent range surrounding that dimension and/or value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A converting roll comprising:
a. a core, said core having a radius ranging from about 1 inch (2.54 cm) to about 12 inches (30.48 cm) and an outer surface; and,
b. an elastomeric roll cover, said elastomeric roll cover having a hardness ranging from about 80 P&J to about 140 P&J and having a thickness ranging from about 0.25 inches (6.35 mm) to about 1.25 inches (31.75 mm);
wherein the elastomeric roll cover is disposed about said outer surface of said core.

2. The converting roll of claim 1 wherein said converting roll has a length ranging from about 100 inches (2.5 m) to about 110 inches (2.79 m).

3. The converting roll of claim 1 wherein said core has a radius ranging from about 5 inches (12.7 cm) to about 10 inches (25.4 cm).

4. The converting roll of claim 1 wherein said hardness of said elastomeric roll cover has a tolerance of about (±5 P&J).

5. The converting roll of claim 1 wherein said hardness of said elastomeric roll cover ranges from about 90 P&J to about 130 P&J.

6. The converting roll of claim 5 wherein said hardness of said elastomeric roll cover ranges from about 95 P&J to about 115 P&J.

7. The converting roll of claim 1 wherein said thickness of said elastomeric roll cover ranges from about 0.5 inches (1.27 cm) to about 1.0 inch (2.54 cm).

8. The converting roll of claim 7 wherein said thickness ranges from about 0.5 inches (1.27 cm) to about 0.75 inches (1.91 cm).

9. A converting roll comprising:
a. a core, said core comprising a radius ranging from about 1 inch (2.54 cm) to about 12 inches (30.48 cm);
b. a base layer disposed about an outer surface of said core, said base layer having a hardness ranging from about 0.5 P&J to about 3.0 P&J and a base layer radius ranging from about 4 inches (10.16 cm) to about 12 inches (30.48 cm); and,
c. an elastomeric roll cover disposed about an outer surface of said base layer, said elastomeric roll cover having a hardness ranging from about 80 P&J to about 140 P&J and a thickness ranging from about 0.25 inches (6.35 mm) to about 1.75 inches (44.5 mm).

10. The converting roll of claim 9 wherein said converting roll has a length ranging from about 100 inches (2.5 m) to about 110 inches (2.79 m).

11. The converting roll of claim 9 wherein said core has a radius ranging from about 5 inches (12.7 cm) to about 10 inches (25.4 cm).

12. The converting roll of claim 9 wherein said hardness of said elastomeric roll cover has a tolerance of about ±5 P&J.

13. The converting roll of claim 9 wherein said hardness of said elastomeric roll cover ranges from about 90 P&J to about 130 P&J.

14. The converting roll cover of claim 13 wherein said hardness of said elastomeric roll cover ranges from about 95 P&J to about 115 P&J.

15. The converting roll of claim 9 wherein said thickness of said elastomeric roll cover ranges from about 0.25 inches (6.35 mm) to about 1.75 inches (31.75 mm).

16. The converting roll of claim 15 wherein said thickness of said elastomeric roll cover ranges from about 0.5 inches (1.27 cm) to about 1.5 inches (3.81 cm).

17. The converting roll of claim 16 wherein said thickness of said elastomeric roll cover ranges from about 0.75 inches (1.91 cm) to about 1.25 inches (31.75 mm).

18. The converting roll of claim 9 wherein said base layer has a hardness ranging from about 1 P&J to about 2 P&J.

19. A converting roll comprising:
a. a core, said core having a radius ranging from about 5 inches (12.7 cm) to about 10 inches (25.4 cm);
b. a base layer disposed about a surface of said core, said base layer having a hardness ranging from about 1.0 P&J to about 2.0 P&J and a base layer radius ranging from about 5 inches (12.7 cm) to about 11 inches (27.94 cm); and,
c. an elastomeric roll cover disposed about a surface of said base layer, said elastomeric roll cover having a hardness ranging from about 95 P&J (±5 P&J) to about 115 P&J (±5 P&J) and a thickness ranging from about 0.75 inches (1.91 cm) to about 1.25 inches (31.75 cm).
